(19) United States
(12) Patent Application Publication
(10) Pub. No.: US 2013/0268511 A1
(43) Pub. Date: Oct. 10, 2013

(54) URL Annotations

(71) Applicants: Peter Richard Bailey, Kirkland, WA (US); Girish Kumar, Kirkland, WA (US); Ryen William White, Woodinville, WA (US); Nathan Buggia, Seattle, WA (US); Keith Alan Regier, Kirkland, WA (US)

(72) Inventors: Peter Richard Bailey, Kirkland, WA (US); Girish Kumar, Kirkland, WA (US); Ryen William White, Woodinville, WA (US); Nathan Buggia, Seattle, WA (US); Keith Alan Regier, Kirkland, WA (US)

(73) Assignee: MICROSOFT CORPORATION, Redmond, WA (US)

(21) Appl. No.: 13/441,904

(22) Filed: Apr. 8, 2012

(51) Int. Cl. G06F 17/30

(52) U.S. Cl. 707/722; 707/E17.141

(57) ABSTRACT

A search engine configured to respond to a search query with a search results page is presented. The search engine includes at least one annotated search result in the search results page. The at least one annotated search results is annotated according to user data independent of the basis by which the search results are identified. The search results page is generated to include user-actionable controls by which a user can update the search results according to update criteria. The update criteria is used in a feedback loop to improve the user data upon which search results are personalized and/or annotated.

### BACKGROUND

More and more, people are interacting with and through online services, including but not limited to social networking sites, search engines, online shopping sites, libraries, entertainment/gaming sites, music and video streaming sites, and the like. All of these online services work at a basic level of functionality with each new (or unidentified) user, yet nearly all of these online services work “better” when a user is identified and has provided information about himself/herself to the service. With specific information about the user, these online services are able to “personalize” their services—i.e., provide services specifically tailored and targeted to the user.

User interaction with an online search engine has been well-established for some time: a user submits a search query to the search engine; the search engine identifies content relevant to the search query; the search engine generates one or more search results pages having search results (i.e., hyperlinks to content) to the identified content; and returns the one or more search results pages to the user in response to the search query. While some of the search results that are returned in the search results pages makes sense to the user, quite often the user is left wondering, “Why is this search result presented to me?” This is especially true as search engines personalize the search results to the particular user that submits the search query.

### SUMMARY

The following presents a simplified summary in order to provide a basic understanding of various embodiments described herein. This summary is not an extensive overview, and it is not intended to identify key and/or critical elements or to delineate the scope thereof. The sole purpose of this summary is to present some concepts in a simplified form as a prelude to the more detailed description that follows.

According to aspects of the disclosed subject matter, a method for responding to a search query from a user is presented. The method comprises the following, including obtaining a set of search results relevant to the search query. After obtaining the set of search results, a subset of the search results of the obtained set of search results is annotated according to user data associated with the user. Search results pages are generated from the set of search results. The search results pages includes at least one annotated search result of the subset of annotated search results. Moreover, for each annotated search result included in the search results pages, a corresponding user-actionable annotation indicator is included proximate to the annotated search result. Finally, the search results pages are returned in response to the search query.

According to additional aspects of the disclosed subject matter, a computer-readable medium bearing computer-executable instructions is presented. The instructions, when executed on a computing system comprising at least a processor retrieved from the medium, carry out a method for responding to a search query from a user. The method comprises the following steps, including presenting an initial set of search results relevant to a search query received from a user. In one embodiment, the initial set of search results includes at least one annotated search result. The annotation corresponding to the at least one annotated search result is presented in response to a user request to display the annotation. The annotation comprises a plurality of annotation relationships, wherein each annotation relationship describes a basis for which the at least one search result is relevant to the user. A selection of an annotation relationship is received, indicative of a request to update the initial set of search results according to the basis of the selected annotation relationship. Updating the initial set of search results may comprise any (or a combination) of the actions of filtering the search results according to the basis of the selection annotation relationship, reordering the initial set of search results with an emphasis (weighting) placed on the basis of the selected annotation relationship, or obtaining an entirely new set of search results (with an emphasis on the basis of the selected annotation relationship). An updated set of search results updated from the initial set of search results is obtained according to the basis of the selected annotation relationship. The updated set of search results is then presented to the user.

According to still further aspects of the disclosed subject matter, a computer system for presenting search results to a search query is presented. The system comprises a processor and a memory, wherein the processor executes instructions stored in the memory as part of or in conjunction with additional components to respond to a search query. These additional components comprise a network communication component for communicating with one or more computing devices over a communication network. The computer system further comprises a search results retrieval component that obtains an initial set of search results according to information in a content index responsive to receiving a search query from a user. An annotation component annotates a subset of the initial set of search results according to user signals associated with the user. The subset of annotated search results is annotated independently of the rationale for obtaining the plurality of search results. A search results page generator component generates an initial search results page from the initial set of search results and returns the initial search results page to the user in response to the search query. The initial search results page includes at least one annotated search result of the subset of annotated search results. For each annotated search result included in the one or more search results pages, the search results page generator includes a user-actionable annotation indicator proximate to the annotated search result. A search results update component updates the initial set of search results according to update criteria of an update request received from the user. The search results update component further obtains an updated search results page generated by the search results page generator, and returns the updated search results page to the user in response to the update request.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary process, as executed on a suitably configured search engine, for responding to a search query from a user with annotated search results;

FIG. 2 is pictorial diagram illustrating an exemplary browser view of search results, including annotated search results, according to aspects of the disclosed subject matter;

FIG. 3 is a pictorial diagram illustrating an exemplary browser view of updated search results according to aspects of the disclosed subject matter;

FIG. 4 is a flow diagram illustrating an exemplary routine for responding to a search query with annotated search results;

FIG. 5 is a flow diagram illustrating an exemplary routine for updating search results according to an update criteria associated with an annotated search result;

FIG. 6 is a flow diagram illustrating an exemplary routine for updating search results according to personalization criteria;

FIG. 7 is a block diagram illustrating components of an exemplary search engine 700 configured to respond to a search query with annotated search results; and

FIG. 8 is a block diagram illustrating an exemplary network environment suitable for implementing aspects of the disclosed subject matter.

### DETAILED DESCRIPTION

For purposed of clarity, the use of the term “exemplary” in this document should be interpreted as serving as an illustration or example of something, and it should not be interpreted as an ideal and/or leading illustration of that thing.

For purposes of clarity, a search result is data presented to a user in response to a search query from the user. Typically, a search result is a reference (or hyperlink) to content accessible to the user over a network. An annotated search result is a search result that is associated with an annotation. The term, “annotation,” as used throughout this document, refers to a set of annotation relationships between the subject matter of a search result and a user, i.e., the rationale or basis as to how the subject matter of the search result relates is relevant to the user.

Each annotation relationship describes a single basis for which the user and subject matter of the search result are related. While annotation relationships typically describe a positive affinity between the user and the search result, an annotation relationship may describe a negative affinity between the user and the entity. For simplicity in description, the phrase “annotation relationship between the subject matter of a search result and the (or a) user” will be shortened to “annotation relationship between the search result and the user.”

To visually indicate that a search result has been annotated, an annotation indicator (typically a user-actionable indicator such as an icon) is placed in proximity to the annotated search result. It is through activating the annotation indicator by which the user can view/access the annotation for that search result.

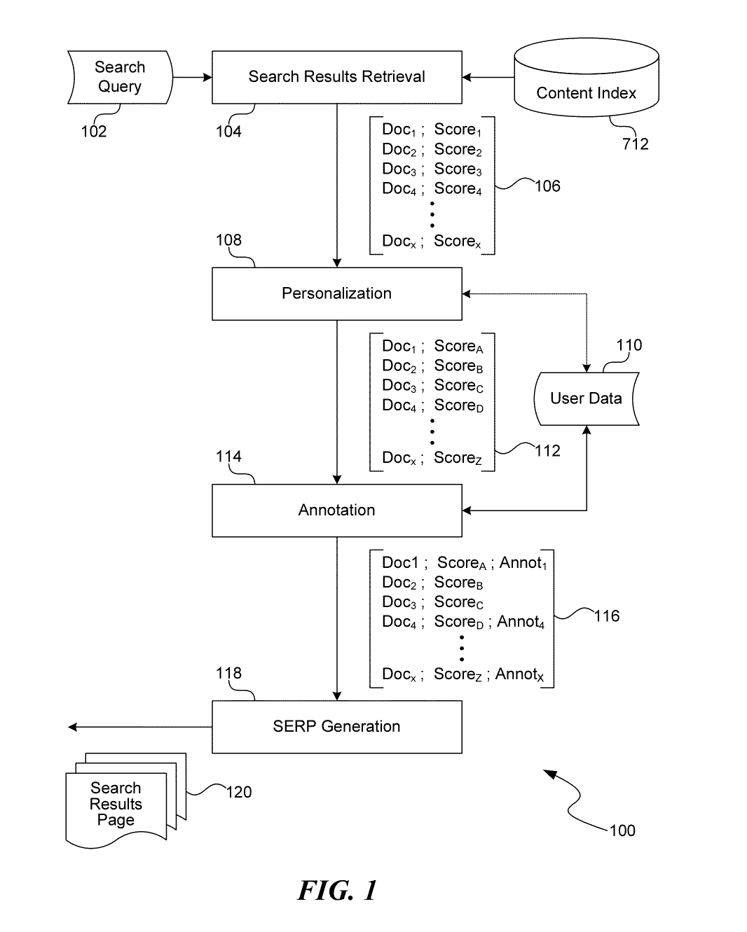

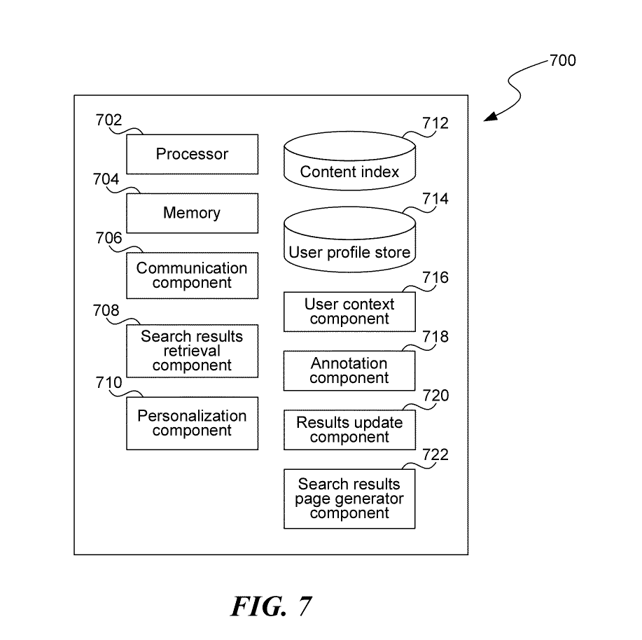

FIG. 1 is a block diagram illustrating an exemplary process 100, as executed on a suitably configured search engine (700 of FIG. 7), for responding to a search query from a user with annotated search results. From top to bottom, with information from a search query 102, a search results retrieval step 104 identifies a plurality of search results from a content index 712 (see FIG. 7). The search results set 106 illustrates an exemplary set of search results retrieved by the search results retrieval step 104. As can be seen in the search results set 106, the search results retrieved from the content index 712 comprise at least a pair of information: a reference to content (denoted as a “Doc”) and a corresponding relevance score. Generally speaking, the relevance score is a relative value signifying the strength of relevance of the referenced document to the subject matter of the search query 102.

At the next step of processing is the personalization step 108. The personalization step takes the search results set 106 generated in the search results retrieval step 104 and personalizes the results according to user data 110. This user data may include, but is not limited to: dynamically determined context information about the user (e.g., the current geographic location of the user, time of day, type of computing device in use, current applications in use, and the like); personalization criteria including data that is stored about the user in a user profile store 714 (see FIG. 7) including both implicit and explicit user and social group preferences; trending topics of interest to the user; current browsing and click-through results; and the like. The result of the personalization step 108 is that the scores associated with the search results are updated, as shown in search results set 112.

Another step in the process 100 is the annotation step 114. While shown in FIG. 1 as following the personalization step 108, in fact the annotation step 114 may be implemented before, concurrently with, or after the personalization step 108. The annotation step 114 adds to the search results sets annotations for select search results. As will be discussed in more detail later, during the annotation step the search results are evaluated and only those that are determined to have sufficiently strong affinity between the user and the search result (more particularly, between the user and the subject matter of the search result) are annotated. The annotation step 114 may rely upon all or part of the user data 110 that is used during the personalization step in generating the annotations for the select search results.

With a search results set 116 that includes search results, personalized scores, and annotation information, the search results page (SERP) generation step 118 generates one or more search results pages 120 from the search results set 116.

According to aspects of the disclosed subject matter, the annotation step 114 determines which search results to annotate and the corresponding annotations (i.e., the set of annotation relationships between the search results and the user) for the selected search results independent of the rationale used to identify the set of search results in the search results retrieval step 104. While it may be that the same criteria are used in both the search results retrieval step 104 and the annotation step 114, the annotation step 114 does not obtain such information from the search results retrieval step 104.

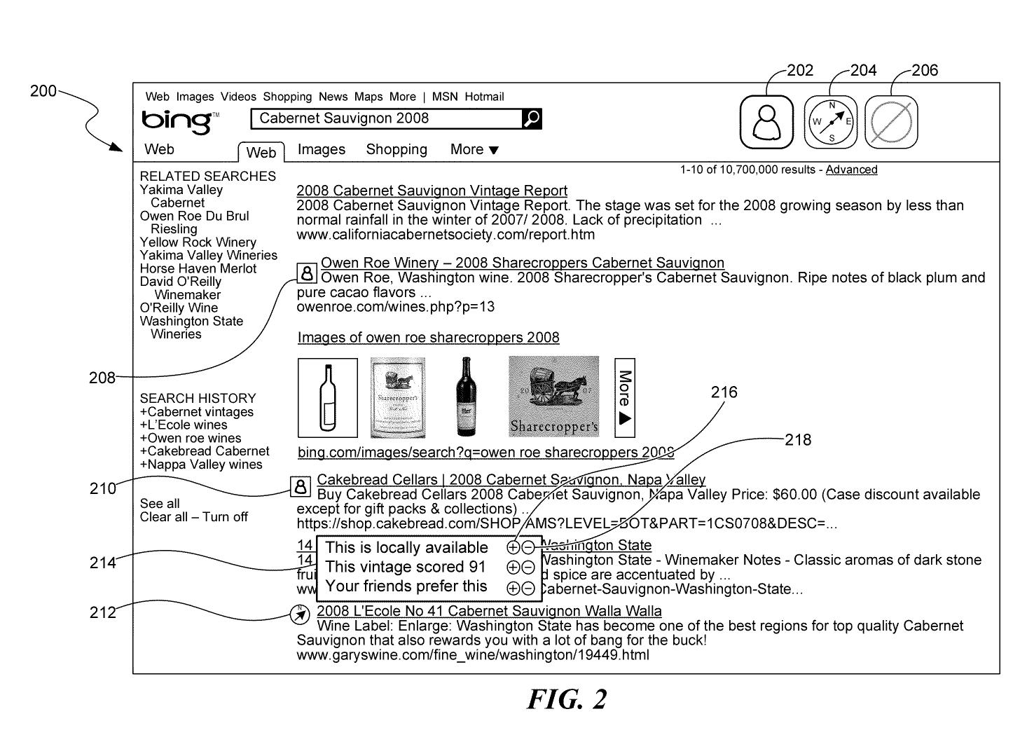

To illustrate annotated search results as well as additional aspects of the disclosed subject matter, reference is now made to FIG. 2. FIG. 2 is pictorial diagram illustrating an exemplary browser view 200 of search results in a search results page, including annotated search results, according to aspects of the disclosed subject matter. Of the search results in this search results page, three of the results are annotated, as indicated by annotation icons 208-212. As mentioned previously, the annotation icons are typically, but not always, user-actionable icons through which a user is able to view the corresponding annotation. For example, the result of clicking on annotation icon 212 is the display of an annotation window 214 showing various annotation relationships between the user and the corresponding search results. Each of the annotation relationships describe a basis for the relationship between the search result (more specifically, the content referenced by the search result) and the user. As can be seen, the first annotation relationship, “This wine is locally available to you,” is based on a geographic availability; the second annotation relationship, “This wine scored 91 in Wine Scores,” is likely based on the user's preference of high quality wine; and the third annotation relationship, “Your friends prefer this wine,” is based the preferences of the user's social network.

Regarding the annotation icons 208-212, according to aspects of the disclosed subject matter the annotation icon corresponds to the predominant annotation relationship in the annotation, i.e., the annotation relationship with the strongest affinity between the user and the search result. In the exemplary case of annotation icon 212, this “compass” icon is a visual indication that locality/geographic location is the predominant annotation relationship of the corresponding annotation. Annotation icons 208 and 210 are, in this exemplary browser view 200, visual indications that personal preferences are the predominant annotation relationships of the corresponding annotations. While only two distinct annotation icons (e.g., annotation icons 208 and 212) are represented in the illustrated browser view 200, this is for illustration purposes and should not be viewed as limiting upon the disclosed subject matter. The disclosed subject matter should be viewed as encompassing any number of icons corresponding to a particular basis for which an annotation relationship is included in an annotation.

Often, an annotation relationship will represent an aspect related to the search query that appeals to the user. For example, the basis of the annotation relationship represented by “This wine is locally available to you,” is a locality/geographic location basis. The user may realize that this is an important consideration at the moment. Hence, according to aspects of the disclosed subject matter, users are provided controls whereby they are able to update the search results according to rationale/basis of an annotation relationship. As shown in annotation window 214, each annotation relationship is followed by a “more” icon, such as icon 216, as well as a “less” icon, such as icon 218. In this example, selecting icon 216 will cause the search engine 700 to update (i.e., filter, reorder and/or re-query) the search results according to the location of the user. Conversely, selecting the “less” icon 218 will cause the search engine 700 to update the search results without consideration to the present location of the user. Moreover, according to further aspects of the disclosed subject matter, selecting a “more” or “less” icon will result in feedback to the search engine regarding the user's overall preferences (which play into the annotation process as discussed earlier.) As part of the user filtering (or reordering/re-querying) the search results, the update criteria may be entered into a feed-back loop to update the user data 110 (FIG. 1) that is used to personalize and annotate the search results.

In a further alternative embodiment, in addition to controls that enable a user to provide more or less weight to a specific criteria (e.g., via controls 216 and 218), an additional control may be displayed that enables the user to instruct the search engine and/or annotation system from tracking a particular facet. For example, in addition to the “more” icon 216 and the “less” icon 218, an addition control may be added whose purpose is to say “do not track this as part of my user profile.” Of course, this type of feedback is also highly relevant user information that is provided to the feed-back loop in updating the user data 110.

According to additional aspects of the disclosed subject matter, the exemplary browser view 200 includes preference dominance icons 202-206. These preference dominance icons provide a visual representation of the predominant preference aspect that was used in ordering the current set of search results. As can be seen, predominance icon 202, corresponding to personal preferences of the user, is highlighted indicating that the search results displayed in the browser view 200 were weighted most heavily in favor of the user preferences. In this example, predominance icon 204, corresponding to the users current geographic location, indicates that the user's current geographic location was considered but was not the predominant factor in ordering the search results displayed in the browser view 200. Further still, predominance icon 206 provides a means whereby the user can turn off the use of user preference signals in ordering the search results that are displayed in the browser view 200. Selecting one of the predominant icons that is not currently highlighted will result in the reordering of the search results. For example, selecting predominance icon 204 will cause the search results in the browser view 200 to be reordered with predominance towards the user's geographic location.

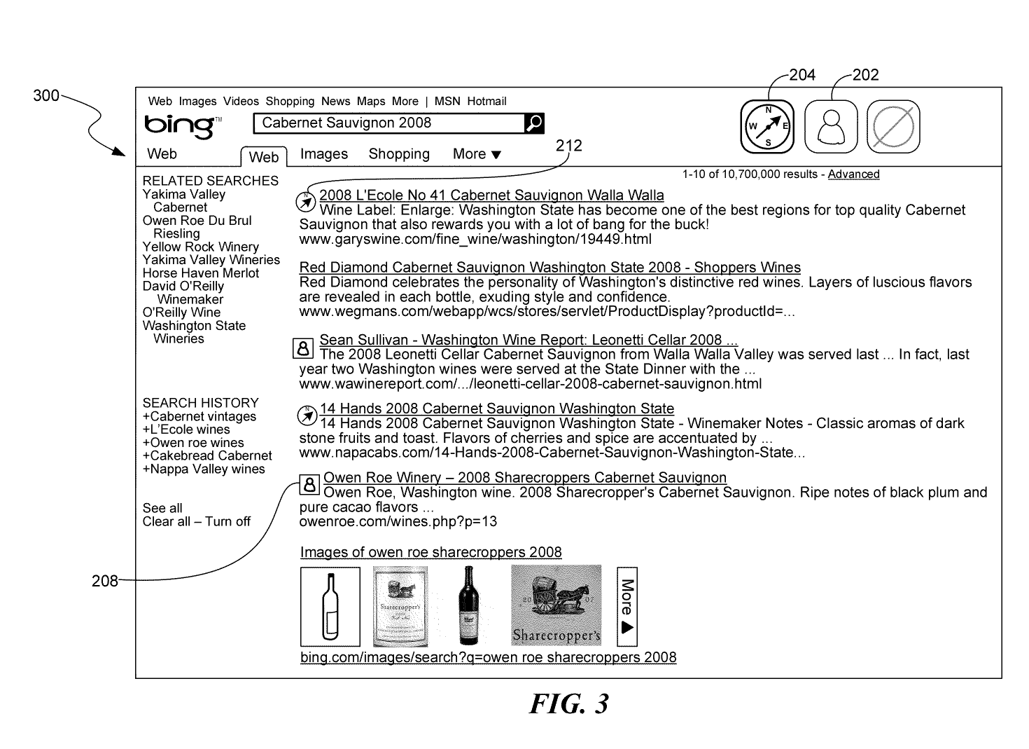

As an example of the updating that can occur, we can assume that the user has selected the “more” icon 216 to update the search results in the browser view 200 according to the users current geographic location. In this regard, FIG. 3 is a pictorial diagram illustrating an exemplary browser view 300 of search results updated according to a user's current geographic location as a result of the user selecting the “more” icon 216 of FIG. 2. As can be seen, in the exemplary browser view 300, for this example the search results that referenced content about wine originating outside of the Washington state region are no longer displayed (though they may be located further down in the search results.) Moreover, the search result corresponding to icon 212 is not at the head of the list of results. Further still, as the search results of the exemplary browser view 300 have been updated according to geographic location/proximity, the preference dominance icons have been reordered and the location icon 204 is now the predominant icon.

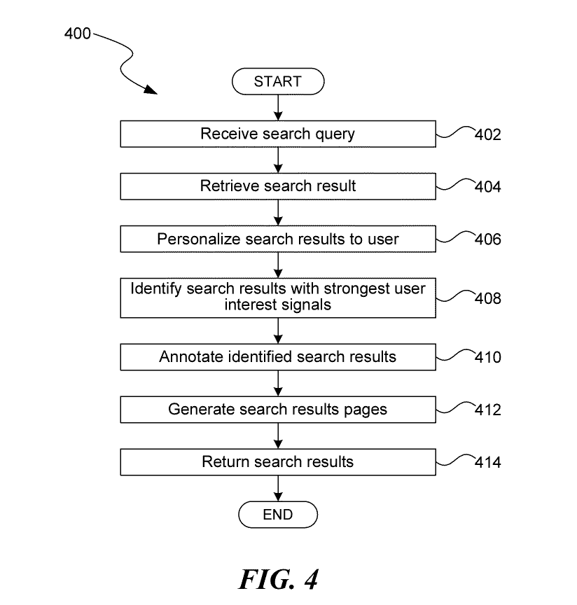

Turning now to FIG. 4, this figure is a flow diagram illustrating an exemplary routine 400, as implemented on a search engine 700, for responding to a search query with annotated search results. Beginning at block 402, the search engine 700 receives a search query from a user. At block 404, the search engine 700 retrieves a plurality of search results from the search engines content index 712 that are relevant to the subject matter of the user's search query.

At block 406, the search engine 700 personalizes the search results retrieved from the content index according to user data 110 corresponding to the user. As indicated previously, the user data may comprise implicit and/or explicit user preferences, including those that are stored in the user profile store 714, and dynamically determined user context information, and preferences of one or more social groups to which the user belongs, trending topics in which the user may have an interest, and the like. As previously mentioned, the results of personalizing the search results is a reordering of the search results according to the user data 110.

At block 408, the search engine 700 identifies the search results with the strongest affinity to the user in preparation for annotating the identified search results. In one non-limiting embodiment, the search engine 700 (via an annotation component 718, FIG. 7) determines annotations for each of the search results and selects those search results that have the greatest affinity to the user. Other methods for identifying the search results with the strongest affinity are also contemplated as falling within the scope of the disclosed subject matter. At block 410, the identified search results are annotated (if they have not already been annotated in the process of identifying the annotations with the strongest user affinity.) Further still, according to one embodiment of the disclosed subject matter, all search results are annotated.

Search results are annotated according to user data 110 independent of the rationale used in retrieving the search results from the content index 712. Further still, the annotation of the search results is independent of the personalization of the search results and, thus, the order in which the search results are personalized and annotated, as shown in the exemplary routine 400 of FIG. 4, is illustrative only and should not be viewed as limiting upon the disclosed subject matter.

At block 412, the search engine 700, via a search results page generator component 722 (FIG. 7), generates one or more search results pages according to the annotated, personalized search results that were retrieved in response to the user's search query. In accordance with various aspects of the disclosed subject matter, as part of generating the one or more search results pages from the personalize, annotated search results, for each annotated search result a user actionable control, such as an annotation icon, and is placed in proximity to the corresponding annotated search result. After generating the one or more search results pages, the search engine 700 returns the search results to the user in response to the search query. Thereafter, the routine 400 terminates.

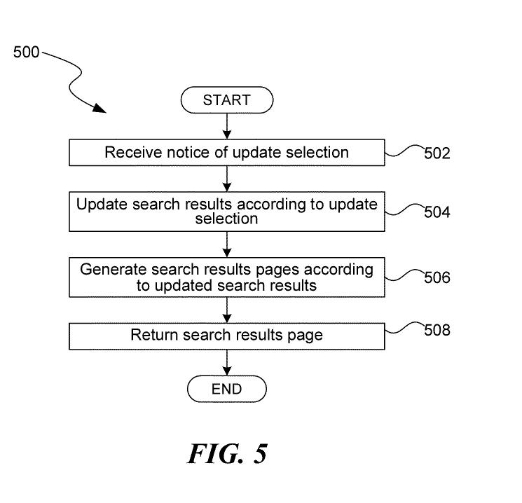

Turning now to FIG. 5, FIG. 5 is a flow diagram illustrating an exemplary routine 500, as implemented by a search engine 700, for updating search results according to an update criteria associated with an annotated search result. Beginning at step 502, the search engine receives notice of an update request. This update request will include update criteria identifying the basis for updating the search results. As discussed above in regard to FIG. 2, an update request may be generated by a user via a selection/action to have the search results updated according to the basis of an annotation relationship. At block 504, the search engine 700 updates the search results currently displayed to the user according to the u criteria. At block 506, the search engine generates a new, updated set of search results pages according to the filtered, reordered, and/or regenerated search results. Of course, this updated set of search results may include annotated search results (as illustrated by icons 208 and 212 of FIG. 3). At block 508, the search engine 700 returns the updated set of search results in response to the update request. Thereafter, the routine 500 terminates. While not shown in the illustrative routine 500, an additional step that may occur is to use the update criteria in a feedback loop in order to improve the accuracy and currency of the user data 110 that is used in both personalizing and annotating the search results.

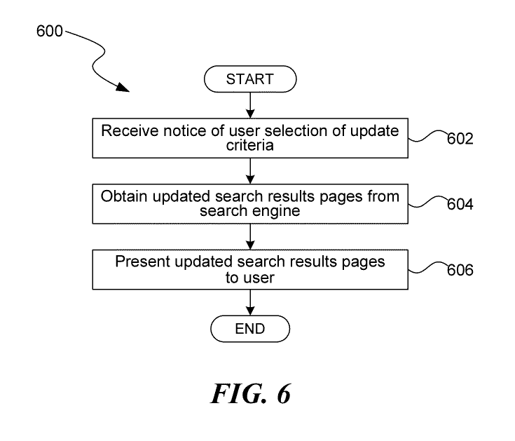

FIG. 6 is a flow diagram illustrating an exemplary routine 600, as implemented as part of the search results page displayed on the user computer, for updating search results according to update criteria. Beginning at block 602, notice was received of a user selection to update the current set of search results according to update criteria. Updating the search results according to update criteria it was discussed by way of example above in regard to FIG. 2, particularly in regard to selecting the “more” icon 216 to update the search results according to a user's current geographic location. At block 604, an updated set of search results pages is obtained from the search engine 700, the search results pages including search results updated (e.g., filtered, reordered, re-queried) according to the update criteria. At block 606, the updated search results pages are presented to the user. Thereafter, the routine 600 terminates.

Regarding the routines of FIGS. 4, 5 and 6, (as well as other processes described throughout this document) it should be appreciated that while they are expressed with discrete steps, these steps should be viewed as being logical in nature and may or may not correspond to any actual, discrete steps. Nor should the order in which these steps are presented be construed as the only order in which the various steps may be carried out. Those skilled in the art will appreciate that logical steps may be combined together or be comprised of multiple steps. Further, while novel aspects of the disclosed subject matter are expressed in routines or methods, this functionality may also be embodied in computer-readable media. As those skilled in the art will appreciate, computer-readable media can host computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

FIG. 7 is a block diagram illustrating components of an exemplary search engine 700 configured to respond to a search query with annotated search results. The search engine 700 includes a processor 702 and a memory 704. As those skilled in the art will appreciate, the processor 702 executes instructions retrieved from memory 704 in carrying out various aspects of the search engine service, including annotating search results.

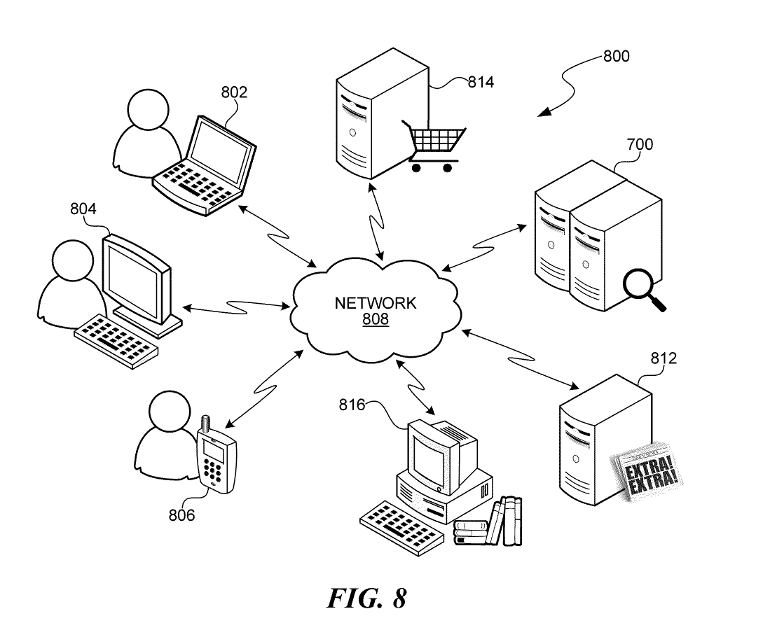

The search engine 700 also includes a network communications component 706 through which the search engine sends and receives communications over a network 808 (FIG. 8). For example, it is through the network communication component 706 that the search engine 700 receives search queries from user computers and returns results responsive to the search queries. The search engine 700 further includes a search results retrieval component 708 and a search results page generation component 722. Regarding the search results retrieval component 708, this logical component is responsible for retrieving or obtaining search results relevant to a user's search query from the content index 712. Once a set of search results responsive to a search query have been retrieved, a personalization component 710 personalizes the search results (including the order of the search results) to the user according to user data 110. At least of portion of the user data comprises user preferences (both explicit and implicit preferences), some of which is stored in a user profile store 714. As mentioned above, user data 110 also may include current user context information that is obtained via a user context component 716.

Also included in the exemplary search engine 700 is an annotation component 718. As already discussed above, according to at least one embodiment the annotation component 718 selects one or more search results for annotation according the affinity between the user and the corresponding search results. For those selected search results (or, in an alternative embodiment, for all search results) the annotation component 718 annotates the search results according to user data 110. The annotation component 718 annotates the search results independent of the bases for which the search results retrieval component 708 obtains the set of search results.

Still further included in the exemplary search engine 700 is a search results update component 720. The search results update component 720 processes the update requests generated by the user (typically from controls within a search results page) and updates the results according to update criteria specified in the update request. Updated search results pages are generated and returned with the updated search results.

Those skilled in the art should appreciate, of course, that many of these components of the exemplary search engine 700 can and should be viewed as logical components for carrying out various functions of a suitably configured search engine 700. These logical components may or may not correspond directly to actual components of a search engine 700 configured to provide search results, including annotated search results, to a user in response to a search query. Moreover, in an actual embodiment, these components may be combined together or broke up across multiple actual components.

Regarding the environment in which the search engine 700 operates, FIG. 8 is a block diagram illustrating an exemplary network environment 800 suitable for implementing aspects of the disclosed subject matter. The illustrative environment 800 includes one or more user computers, such as user computers 802-806, connected to a network 808, such as the Internet, a wide area network or WAN, and the like. Also connected to the network 808 is a search engine 700 configured to provide search results in response to a computer user's search query, including annotated search results.

Those skilled in the art will appreciate that a search engine 700 corresponds to an online search service hosted on one or more computers on, or computing systems distributed throughout, the network 808. The search engine 700 receives and responds to search queries submitted over the network 808 from various users, such as the users connected to user computers 802-806. As already mentioned, in response to receiving a search query, the search engine 700 obtains search results information related and/or relevant to a user's search query (as defined by the terms of search query.) The search results are typically references (largely in the form of hyperlinks) to relevant/related content available from various target sites (such as target sites 812-816) on the network 808. The search results may also include other information such as related and/or recommended alternative search queries, data and facts regarding the subject matter of the search query, products, and/or services related/relevant to the search query, advertisements, and the like. The search engine 700 generates one or more search results pages responsive to the search query based on the search results information. According to various embodiments of the disclosed subject matter, the search engine 700 includes annotated search results with the generated search results pages.

As those skilled in the art will appreciate, target sites, such as target sites 812-816, host content that is available and/or accessible to users (via user computers) over the network 8108. The search engine 700 will be aware of at least some of the content hosted on the many target sites located throughout the network 808, and will store information regarding the hosted content of the target sites in a content index (712 of FIG. 7). The search engine 700 draws from the content index 712 when obtaining search results in response to receiving a search query. As shown in FIG. 8, the target sites include, by way of illustration, a news organization 812, a shopping site 814, and an online library 816. Of course, those skilled in the art will appreciate that any number and type of target sites may be connected to the network 808. Moreover, as is known in the art, some search engines are aware of millions of target sites and the content that is hosted by those target sites.

Suitable user computers for operating within the illustrative environment 800 include any number of computing devices that can communicate with the search engine 700 or target sites 812-814 over the network 808. In regard to the search engine 700, communication between the user computers 802-806 and the search engine 700 include both submitting search queries and receiving a response in the form of one or more search results pages from the search engine 700. User computers 802-806 may communicate with the network 808 via wired or wireless communication connections. These user computers 802-806 may comprise, but are not limited to: laptop computers such as user computer 802; desktop computers such as user computer 804; mobile phone devices such as user computer 806; tablet computers (not shown); on-board computing systems such as those found in vehicles (not shown); mini- and/or main-frame computers (not shown); and the like.

While various novel aspects of the disclosed subject matter have been described, it should be appreciated that these aspects are exemplary and should not be construed as limiting. Variations and alterations to the various aspects may be made without departing from the scope of the disclosed subject matter.

1. A computer implemented method for responding to a search query from a user, the method comprising:
obtaining a set of search results relevant to the search query;
determining a subset of the set of search results to annotate according to user data associated with the user;
annotating the subset of the obtained search results;
generating one or more search results pages from the set of obtained search results, wherein the one or more search results pages includes at least one annotated search result of the subset of annotated search results, and for each annotated search result included in the one or more search results pages, including a corresponding user-actionable annotation indicator proximate to the annotated search result; and
returning the one or more search results pages in response to the search query.

2. The method of claim 1, wherein the subset of the set of search results to annotate is determined according to user data associated with the user independently of the rationale for obtaining the set of obtained search results.

3. The method of claim 2, wherein determining a subset of the set of search results to annotate according to user data associated with the user comprises determining a subset of the obtained search results that have the strongest affinity to the user.

4. The method of claim 1, further comprising personalizing the obtained set of search results according to the user data associated with the user.

5. The method of claim 1, wherein determining a subset of the set of search results to annotate according to user data associated with the user comprises, for each search result in the subset, determining one or more annotation relationships between the user and the search result and associating the one or more annotation relationships with the search results as the annotation for the search result.

6. The method of claim 5, wherein each annotation relationship defines a basis as to why the search result is relevant to the user.

7. The method of claim 6, wherein each user-actionable annotation indicator is configured to present the annotation associated with the corresponding search result.

8. The method of claim 7, wherein the user actionable annotation indicator is an icon pictographically indicative of the basis of the annotation relationship having the greatest affinity to the user among the one or more annotation relationships of the annotation.

9. A computer readable medium bearing computer executable instructions which, when executed on a computing system comprising at least a processor executing the instructions retrieved from the medium, carry out a method for responding to a search query from a user, the method comprising:
obtaining an initial set of search results relevant to a search query received from a user;
determining at least one search result of the initial set of search results to annotate, wherein the determination is made according to user data associated with the user;
annotating the at least one search results;
presenting the initial set of search results relevant to a search query received from a user, the initial set of search results including the at least one annotated search result;
presenting the annotation corresponding to the at least one annotated search result in response to a user request to display the annotation, the annotation comprising a plurality of annotation relationships, each annotation relationship describing a basis for which the at least one search result is relevant to the user;
receiving a selection of an annotation relationship indicative of an updated request to update the initial set of search results according to the basis of the selected annotation relationship;
obtaining an updated set of search results updated from the initial set of search results according to the basis of the selected annotation relationship; and
presenting the updated set of search results to the user.

10. The computer readable medium of claim 9, wherein the at least one annotated search result is identified by an annotation indicator proximate to the at least one annotated search result.

11. The computer readable medium of claim 10, wherein the annotation indicator proximate to the at least one annotated search result is a user actionable indicator configured to present the annotation corresponding to the at least one annotated search result upon activation.

12. The computer readable medium of claim 11, wherein the user actionable annotation indicator is an icon pictographically indicative of the basis of the annotation relationship having the strongest affinity between the user and the corresponding search result among the plurality of annotation relationships of the annotation.

13. The computer readable medium of claim 9, wherein the initial set of search results is a personalized set of search results, personalized to the user according to user data corresponding to the user.

14. The computer readable medium of claim 13, further comprising providing the basis of the selected annotation relationship in a feedback loop to update the user data corresponding to the user.

15. The computer readable medium of claim 9, wherein the at least one annotated search result was annotated independently of the rationale for retrieving the initial set of search results relevant to the search query.

16. A computer system for presenting search results in response to a search query, the system comprising a processor and a memory, wherein the processor executes instructions stored in the memory as part of or in conjunction with additional components to respond to a search query, the additional components comprising:
a network communication component for communicating with one or more computing devices over a communication network;
a search results retrieval component that obtains an initial set of search results according to information in a content index responsive to receiving a search query from a user;
an annotation component that determines a subset of the initial set of search results to annotate according to user data associated with the user, wherein the annotation component determines the subset of initial search results search results to annotate independently of the rationale by which the search results retrieval component obtains the plurality of search results, and wherein the annotation component annotates the subset of the initial set of search results;
a search results page generator component that generates an initial search results page from the initial set of search results and returns the initial search results page to the user for presentation in response to the search query, wherein the initial search results page includes at least one annotated search result of the subset of annotated search results, and for each annotated search result included in the initial search results page, the search results page generator component further includes a user-actionable annotation indicator proximate to the annotated search result; and
a search results update component that updates the initial set of search results according to update criteria of an update request received from the user, and obtains an updated search results page generated by the search results page generator based on the updated set of search results, and returns the updated search results page to the user for presentation in response to the update request.

17. The computer system of claim 16 further comprising a personalization component that personalizes the initial set of search results according to the user data.

18. The computer system of claim 17, wherein the user data comprise any of a present geographic location of the user, personal preferences associated with the user, preferences associated with a social group to which the user belongs, and currently trending topics.

19. The computer system of claim 17, wherein the user actionable annotation indicator proximate to the annotated search result is configured to present the annotation for the corresponding annotated search result upon activation.

20. The computer system of claim 19, wherein the annotation corresponding to the annotated search result comprises a plurality of annotation relationships, each annotation relationship describing the basis for which the search results is relevant to the user, and
wherein the user actionable annotation indicator is an icon pictographically indicative of the basis of the annotation relationship having the greatest affinity to the user among the plurality of annotation relationships of the annotation.
